(19) United States
(12) Patent Application Publication
(10) Pub. No.: US 2005/0237762 A1
(43) Pub. Date: Oct. 27, 2005

(54) Lighting device

(75) Inventor: Johannes Marra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/526,925

(22) PCT Filed: Sep. 1, 2003
(86) PCT No.: PCT/IB03/03856

§ 371 Date: Mar. 8, 2005

(30) Foreign Application Priority Data
Sep. 12, 2002 (EP) 02078760.2

(51) Int. Cl. F21V 7/04

(52) U.S. Cl. 362/551

(57) ABSTRACT

A lighting device comprising at least one light source (3) arranged in a housing, in which the housing comprises a light guide (6,7) on at least one side, which light guide includes an input element (8,8′) facing towards the light source (3), which functions to receive light radiated from the light source (3), as well as an output element (9,9′) facing away from the light source (3), which functions to emit a light beam being passed through the light guide (6,7), and in which the housing further comprises a diffuse light reflector (5) for the diffuse reflection of light radiated from the light source (3) into the direction of the input element (8,8′), a special feature being the fact that the input element (8,8′) of the light guide (6,7) is configured as a collimator so as to enable a light beam to be coupled into the light guide (6,7) within a restricted angular range.

The invention relates to a lighting device comprising at least one light source arranged in a housing, in which the housing comprises a light guide on at least one side, which light guide includes an input element facing towards the light source, which during operation of the lighting device functions to receive light radiated from the light source, as well as an output element facing away from the light source, which during operation of the lighting device functions to emit a light beam being passed through the light guide, and in which the housing further comprises a diffuse light reflector for the diffuse reflection of light radiated from the light source into the direction of the input element during operation of the lighting device.

Such a lighting device is generally known. In the known lighting device, the light source is arranged in a cylindrical housing, on either end of which straight cylindrical light guides and their straight input elements of glass or quartz are present. The shapes of the light guide and the input element are entirely similar to those of an ordinary straight optical fibre. Said cylindrical housing, which is made from sintered Al₂O₃ powder, has an optically roughened surface facing towards the light source, which functions to ensure that light radiated from the light source is diffusely reflected and eventually coupled into the input element of the light guide in a more or less directed manner, without an image of the light source being recognizable in any way from a specific angular distribution of (the intensity of) the emitted light from the output element.

One drawback of the known lighting device is that the housing consisting of sintered Al₂O₃ powder that is used therein is very difficult, or altogether impossible, to produce without impurities contained therein, so that there will always be some degree of light absorption by the housing. On the one hand this results in a lower light output, whilst on the other hand there is a difference in colour between light radiated from the light source and light being emitted from the output element of the light guide, precisely because light radiated from the light source can undergo many reflections inside the housing and a relatively great deal of light is absorbed, therefore. Furthermore, no collimation of the light received by the input element of the light guide takes place in the straight cylindrical light guide, so that loss of light caused by light absorption or light scattering due to the presence of impurities on the outer surface of the light guide or from damage caused thereto occur inside the light guide. Furthermore, the angular range of the emitted light beam from the output element of the light guide is substantially not restricted.

The object of the invention is to overcome the drawbacks of the prior art, and in order to accomplish that objective a lighting device of the kind referred to in the introduction is characterized in that the input element of the light guide is configured as a collimator so as to enable a light beam to be coupled into the light guide within a restricted angular propagation range. The input element is preferably conical or paraboloid in shape, whilst the restricted angular propagation range of the collimated light coupled into the light guide ranges between the boundaries 0° and 40° relative to the average direction of propagation of the light in the light guide. As a result, the light in the light guide is prevented from undergoing a relatively large number of reflections with the outer surface of the light guide, so that the extent of light loss caused by absorption and/or scattering events on said outer surface of the light guide can be limited. Furthermore, said collimation makes it possible to restrict the angular range of the emitted light from the output element of the light guide.

In order to restrict the angular range of the light beam emitted from the output element even further, it is preferable to configure said output element as an outwardly (seen from the light guide) curved lens, or to dispose at least one optical lens adjacent to the output element in such a way that the emitted light beam from the output element is substantially entirely passed through the said at least one optical lens. In another preferred embodiment of the said lighting device according to the invention, the output element during operation of the lighting device emits the light beam into a specially shaped lighting fixture, within which the light beam emitted from the output element is imparted an additional spatial angular restriction. In yet another preferred embodiment of the lighting device according to the invention, a specular reflecting surface of a mirror element is disposed in a preferred spatial orientation near the output element. The preferred spatial orientation of said specular reflecting surface being chosen such that the light beam emitted from the output element is substantially entirely reflected away from said specular reflecting surface of said mirror element thereby changing the average propagation direction of the emitted light beam from the output element into another preferred average propagation direction. In still another preferred embodiment of the lighting device according to the invention, said lighting device comprising a specular reflecting surface of a mirror element disposed near the output element, the spatial orientation of said specular reflecting surface of said mirror element is adjustable thus enabling to obtain an adjustable average propagation direction of light beam from said specular reflecting surface of said mirror element.

In one preferred embodiment of a lighting device according to the invention, a colour filter is arranged on, adjacent or near the output element. Said colour filter can be arranged in the light guide in such a manner that at least part of a cross-section of the light guide lying in a plane perpendicular to the average propagation direction of the light in the light guide is covered by the colour filter. Furthermore it is possible to position the colour filter just outside the output element of the light guide, in such a manner that a light beam emitted from the output element is at least partly passed through the colour filter. In another preferred embodiment, the present lighting device comprises a rotatable colour wheel comprising a number colour filter, for selectively arranging a particular colour filter on or near the output element by rotation of the colour wheel. The selected colour filter being positioned such that the emitted light beam from the output element is at least partly passed through the selected colour filter. The presence of the said colour wheel thus enabling an adjustable colouring of the emitted light from the said lighting device.

In another preferred embodiment of a lighting device according to the invention, a layer, for example a cladding layer, which is at least substantially impervious to light in the light guide is arranged on at least part of the outer surface of the light guide. Such an impervious layer is obtained when the optical refractive index of the aforesaid impervious layer is lower than the optical refractive index of the light guide. The presence of the aforesaid layer has this advantage that reflection of the light in the light guide occurs at the interface between the light guide and the layer which is substantially impervious to light in the light guide, thus preventing loss of light resulting from absorption and/or scattering of light caused by impurities on and/or damage to the outer surface of the layer which is substantially impervious to light in the light guide.

In another preferred embodiment of a lighting device according to the invention, the diffuse light reflector comprises a diffuse reflective layer arranged on a side of the housing that faces towards the light source.

In another preferred embodiment of a lighting device according to the invention, the diffuse light reflector comprises at least one light-transmitting element bounding a space at least partially and forming an inner side of the housing, as well as a diffusely reflective powder present inside said space. The powder, which is in particular of the “free-flowing” type, preferably comprises calcium halophosphate, calcium pyrophosphate, BaSO₄, MgO, YBO₃, TiO₂ or Al₂O₃ particles. Such a powder is resistant against high temperatures, whilst important chemical properties thereof do not de a result of being exposed to high temperatures, light and/or moisture. The light-transmitting element on the one hand provides a limited degree of reflection of the incident light thereon, and on the other hand it directs part of the incident light thereon towards the powder. The powder, in turn, provides diffuse reflection of said light. Said powder may be mixed with colour pigments. This provides the decorative effect whereby it appears as if (partially) coloured light is being emitted by the lamp.

In another preferred embodiment of a lighting device according to the invention, the particles of said powder have an average diameter ranging between 0.1 and 100 μm, in particular 5 to 20 μm. In order to obtain a “free-flowing” type powder, said particles are mixed with fine-grained Al₂O₃ particles having an average diameter which ranges between 10 and 50 nm. The amount of the latter fine-grained particles, also known as Alon-C (Degussa, Frankfurt), preferably ranges between 0.1 and 5 wt. %, in particular 0.5 to 3 wt. %.

In another preferred embodiment of a lighting device according to the invention, said powder is incapable of absorbing light, at least light having a wavelength in the visible wavelength range. Any loss of light in this wavelength range due to absorption is thus prevented.

In another preferred embodiment of a lighting device according to the invention, a surface of the light-transmitting element facing towards the light source is optically roughened. A surface of the light-transmitting element facing towards the powder may likewise be optically roughened. This enhances the diffuse nature of the light being reflected by the diffuse light reflector.

In another preferred embodiment of a lighting device according to the invention, the diffuse light reflector comprises at least two spaced-apart elements forming an intermediate space between them, in which one element facing towards the light source forms the light-transmitting element, and in which the diffusely reflective powder is present in said intermediate space. In particular, the diffuse light reflector comprises at least two concentric, light-transmitting elements, which are in particular made of glass or quartz. More in particular, the diffuse light reflector comprises at least an outer metallic element facing away from the light source and an inner glass or quartz glass (i.e. glass with an SiO2-contents of at least 95 percent by weight) element facing towards the light source, said elements mutually being spaced apart. The elements being spaced apart by a spacing preferably greater than or equal to 0.5 mm, in particular greater than or equal to 1 mm, more in particular greater than or equal to 2 mm. Experiments have shown that, these are the most suitable spacing sense that when a typical volume packing density of 30-60 volume percent is used in the spacing, a sufficient amount of powder is present to substantially completely reflect incident light thereon.

The invention also relates to a method for manufacturing a lighting device, in which at least one light source arranged in a housing is supplied and in which a light guide is arranged on at least one side of the housing, which light guide includes an input element facing towards the light source, which during operation of the lighting device functions to receive light radiated from the light source, as well as an output element facing away from the light source, which during operation of the lighting device functions to emit a light beam being passed through the light guide, and in which the housing is provided with a diffuse light reflector for the diffuse reflection of light radiated from the light source into the direction of the input element so as to increase the light output of the lighting device during operation of the lighting device. A special feature being the fact that the input element of the light guide is configured as a collimator so as to enable a light beam to be coupled into the light guide in the input element to propagate within a restricted angular range.

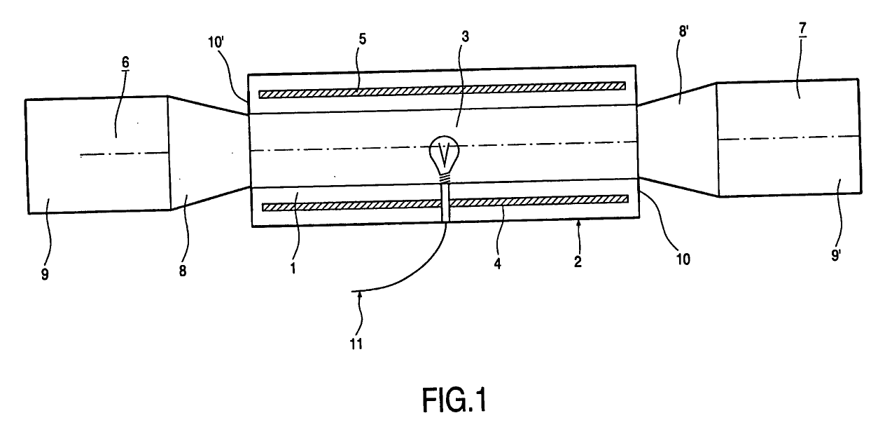

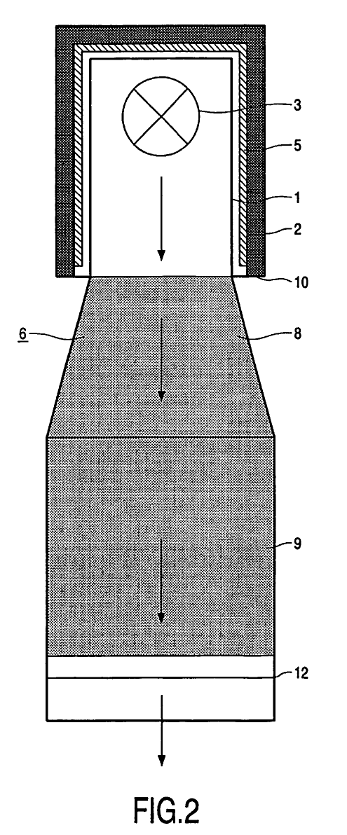

The invention will now be explained in more detail with reference to FIGS. 1 and 2 illustrated in a drawing, which figures are schematic side elevations of two variants of a lighting device according to the invention.

FIG. 1 shows a lighting device consisting of two concentric tubes 1,2 made of quartz, which form a housing for a lamp 3 accommodated therein. The housing is either filled with air or with an inert gas such as nitrogen or argon, or it is under a vacuum. Tubes 1,2 bound a sealed intermediate space 4 between them, which space is filled with a diffuse light reflector in the form of a powder 5, which diffusely reflects light. Said powder 5, which is preferably of the “free-flowing” type, comprises calcium halophosphate, calcium pyrophosphate, BaSO₄, MgO, YBO₃, TiO₂ or Al₂O₃ particles. The effect of said particles is that the light radiated from the lamp 3 is diffusely reflected into the direction of light guides 6,7 present on either side of the concentric tubes 1,2. To that end, said light is received by input elements 8,8′ of the light guides 6,7 and emitted by output elements 9,9′ of the light guides 6,7. The input elements 8,8′ are conical in shape and function as collimators, in the sense that the angular propagation range of the incoupled incident light thereon is restricted to within a more narrow angular propagation range when this light propagates through the light guides 6,7. The diffuse reflection can furthermore be optimised by optically roughening the tube 1 on its side facing towards the lamp 3. In order to prevent reflection losses, reflection holders 10, 10′ are provided, which reflection holders are mounted between space 4 and the input elements 8,8′. The lamp 3 is fed from a power supply 11 disposed outside the housing.

In FIG. 2 those parts that correspond to parts shown in FIG. 1 are indicated by the same reference numerals. The difference with FIG. 1 is that a light guide is arranged on one side of the housing, whilst furthermore a colour filter 12 is fitted in the light guide.

The invention is not limited to the embodiment as discussed above, it also extends to other variants that fall within the scope of the appended claims.

1. A lighting device comprising at least one light source arranged in a housing, in which the housing comprises a light guide on at least one side, which light guide includes an input element facing towards the light source, which during operation of the lighting device functions to receive light radiated from the light source, as well as an output element facing away from the light source, which during operation of the lighting device functions to emit a light beam being passed through the light guide, and in which the housing further comprises a diffuse light reflector for the diffuse reflection of light radiated from the light source into the direction of the input element during operation of the lighting device, characterized in that the input element of the light guide is configured as a collimator so as to enable a light beam to be coupled into the light guide within a restricted angular range.

2. A lighting device according to claim 1, wherein the input element is conical or paraboloid in shape.

3. A lighting device according to claim 1, wherein the restricted angular range of the collimated light coupled into the light guide in particular ranges between the boundaries 0° and 40° relative to the average direction of propagation of the light in the light guide.

4. A lighting device according to claim 1, wherein said output element is an outwardly curved lens or at least one optical lens adjacent to the output element disposed in such a way that the emitted light beam from the output element is substantially entirely passed through the said at least one optical lens.

5. A lighting device according to claim 1, wherein a specular reflecting, preferably adjustable, surface of a mirror element is disposed in a preferred spatial orientation near the output element.

6. A lighting device according to claim 1, wherein a colour filter is arranged on or near the output element.

7. A lighting device according to claim 1, wherein the lighting device comprises on or near the output element a rotatable colour wheel comprising a number colour filters.

8. A lighting device according to claim 1, wherein the diffuse light reflector comprises a diffusely reflective layer arranged on a side of the housing that faces towards the light source.

9. A lighting device according to claim 1, wherein the diffuse light reflector comprises at least one light-transmitting element bounding a space at least partially and forming an inner side of the housing, as well as a diffuse reflective powder present inside said space.

10. A lighting device according to claim 9, wherein said powder comprises calcium halophosphate, calcium pyrophosphate, BaSO₄, MgO, YBO₃, TiO₂ or Al₂O₃ particles.

11. A lighting device according to claim 10, wherein the particles have an average diameter ranging between 0.1 and 100 μm, in particular 5 to 20 μm.

12. A lighting device according to claim 10, wherein said particles are mixed with fine-grained Al₂O₃ particles having an average diameter which ranges between 10 and 50 nm.

13. A lighting device according to claim 12, wherein the amount of fine-grained Al₂O₃ particles having an average diameter ranging between 10 and 50 nm ranges between 0.1 and 5 wt. %, in particular 0.5 to 3 wt. %.

14. A lighting device according to claim 9, wherein said powder is a “free-flowing” type powder.

15. A lighting device according to claim 9, wherein the powder is incapable of absorbing light, at least light having a wavelength in the visible wavelength range.

16. A lighting device according to claim 9, wherein a surface of the light-transmitting element facing towards the light source is optically roughened.

17. A lighting device according claim 16, wherein a surface of the light-transmitting element facing towards the powder is likewise optically roughened.

18. A lighting device according to claim 9, wherein the diffuse light reflector comprises at least two spaced-apart elements forming an intermediate space between them, in which one element facing towards the light source forms the light-transmitting element, and in which the diffusely reflective powder is present in said intermediate space.

19. A lighting device according to claim 18, wherein said spacing is greater than or equal to 0.5 mm, in particular greater than or equal to 1 mm, more in particular greater than or equal to 2 mm.

20. A lighting device according to claim 18, wherein the diffuse light reflector comprises at least two concentric, light-transmitting elements, which are in particular made of glass or quartz.

21. A lighting device according to claim 18, wherein the diffuse light reflector comprises at least an outer metallic element facing away from the light source and an inner glass or quartz glass element facing the light source, said elements mutually being spaced apart.

22. A method for manufacturing a lighting device, in which at least one light source arranged in a housing is supplied and in which a light guide is arranged on at least one side of the housing, which light guide includes an input element facing towards the light source, which during operation of the lighting device functions to receive light radiated from the light source, as well as an output element facing away from the light source, which during operation of the lighting device functions to emit a light beam being passed through the light guide, and in which the housing is provided with a diffuse light reflector for the diffuse reflection of light radiated from the light source into the direction of the input element so as to increase the light output of the lighting device during operation of the lighting device, characterized in that the input element of the light guide is configured as a collimator so as to enable a light beam to be coupled into the light guide within a restricted angular range.
